(19) United States
(12) Patent Application Publication
(10) Pub. No.: US 2020/0001232 A1
(43) Pub. Date: Jan. 2, 2020

(54) CARBON DIOXIDE REMOVAL FROM STEAM PRODUCT FROM DIRECT CONTACT STEAM GENERATION PROCESS

(71) Applicant: HER MAJESTY THE QUEEN IN RIGHT OF CANADA AS REPRESENTED BY THE MINISTER OF NATURAL RESOURCES, Ottawa (CA)

(72) Inventors: Mohammad Asiri, Ottawa (CA); Ted Herage, Stittsville (CA); Bruce Clements, Nepean (CA); Richard Pomalis, Ottawa (CA); Lijun Wu, Kanata (CA); Johnny Matta, Orleans (CA); Steven Chen, Nepean (CA)

(21) Appl. No.: 16/456,183

(22) Filed: Jun. 28, 2019

Related U.S. Application Data
(60) Provisional application No. 62/691,697, filed on Jun. 29, 2018.

(51) Int. Cl. B01D 53/34; B01D 53/75; B01D 53/78; B01D 53/62

(52) U.S. Cl. CPC B01D 53/343; B01D 53/75; B01D 2257/504; B01D 53/62; B01D 53/78

(57) ABSTRACT

A system for carbon dioxide removal from product from a direct contact steam generation system is provided. The system comprises a direct contact steam generation system, a pressurized heat recovery system, and a CO₂ separation system, wherein the direct contact steam generation system converts a gaseous, liquid or solid fuel, in the presence of oxygen, using a moderate water, to produce a mixed vapour stream to be then led into the pressurized heat recovery system to produce a partially condensed product, which is led into the CO₂ separation system to reduce the CO₂ content to produce a CO₂-lean liquid product, and the pressurized heat recovery system utilizes latent heat of the mixed vapour stream to produce a lower pressure vapour stream from the CO₂-lean liquid product exiting the CO₂ separation system.

### CROSS-REFERENCE TO RELATED APPLICATIONS

This application claims priority to U.S. Provisional Application Ser. No. 62/691,697, filed Jun. 29, 2018, the entire contents of which are incorporated herein by reference.

### FIELD OF THE INVENTION

The invention relates to separation and removal of carbon dioxide (CO₂) from steam product from the direct contact steam generation process.

### BACKGROUND OF THE INVENTION

Climate change has been widely recognized as an environmental threat to the world. A recent report by the International Energy Agency shows that with the current climate policies, temperature is likely to increase by between 3.6 and 5.3° C., with most of that increase occurring in this century. A temperature increase of this magnitude would cause significant hardship to mankind, for example, in the form of rising sea levels, reduced freshwater and food availability.

Globally, annual emissions of carbon dioxide, the primary greenhouse gas, reached 37.1 billion tonnes in 2018, their highest level ever. During the last decade, worldwide annual emissions growth was higher than at any time in the past. So far, the world has not effectively responded to this challenge. Because of the global nature of climate change, most countries have been reluctant to undertake significant effort to reduce emissions without a guarantee that others will do the same, perceiving that the majority of benefits from such an effort will accrue to other countries. The European Union has implemented an emission trading system as well as renewable energy targets, and conditions the stringency of its domestic emission reduction targets on action by other countries. Canada and other countries have also taken modest steps to reduce emissions. However, Canada is falling behind other countries in the ambition and scope of its climate policies, and appears almost certain to miss (by a significant margin) its 2020 emission reduction target. Canada has repeatedly affirmed its commitment to avoiding dangerous climate change.

The direct contact steam generation process was initially developed in response to, inter alia, interests by Canadian oil producers to investigate the benefits of co-injection of CO₂ into Steam Assisted Gravity Drainage reservoirs. The approach generates a mixed stream of steam and CO₂.

Generally speaking, a field unit oxygen-fired steam generator utilizing the direct contact steam generation technology operating at ambient pressure or above may produce a flue gas stream containing <15 mol % CO₂ content.

Concerns over the impact of the high CO₂ concentration on an oil well's overall production rates, throughout its active life, lead to the need for a method of controlling the CO₂ content of the injected steam prior to its injection.

Therefore, a method of separating CO₂ from flue gas is required in order to generate a high purity CO₂ stream (>85 mol % CO₂) suitable for sequestration. The remaining flue gas is predominantly steam for Steam Assisted Gravity Drainage applications.

Current carbon capture methods utilize chemical scrubbing, membrane gas separation, or other techniques, for example, biological technologies. It is possible to get a low degree of separation by utilizing a condensation/evaporator scheme.

In order for chemical scrubbing to be applied to Steam Assisted Gravity Drainage and CO₂ sequestration operations, additional equipment and energy are required for chemical regeneration and release of the captured CO₂ from the absorbent chemical.

Currently, commercially available membranes that selectively transmit CO₂ are typically used for natural gas processing. The CO₂ permeability of these membranes are negatively impacted by condensable species in the flue gas, making them inappropriate for separating CO₂ from steam. Additionally, the separated CO₂ is at low pressure, thus require recompression to make suitable for sequestration.

Current biological technologies are generally unsuitable for high temperature applications, making it infeasible for separating CO₂ from steam. An impractically large volume of biomass would also be required for processing the projected system output rate.

Current single stage condensation/evaporator schemes have low separation efficiencies and are thermally inefficient.

Therefore, there remains the need for a method of efficiently controlling the CO₂ fraction of the injected steam.

### SUMMARY OF THE INVENTION

The present disclosure describes a method for removal of carbon dioxide (CO₂) from steam product from the direct contact steam generation process.

According to one aspect of the invention, there is provided a system for carbon dioxide removal from product from a direct contact steam generation system, comprising:
a direct contact steam generation system,
a pressurized heat recovery system, and
a CO₂ separation system,

wherein the direct contact steam generation system converts a gaseous, liquid or solid fuel, in the presence of an oxidant and using a moderator water, said fuel, oxygen and water are introduced into the direct contact steam generation system through inlets, to produce a mixed vapour stream,

wherein said mixed vapour stream is then led into the pressurized heat recovery system through connecting means between the direct contact steam generation system and pressurized heat recovery system to produce a partially condensed product,

wherein said partially condensed product is led into the CO₂ separation system through connecting means between the pressurized heat recovery system and pressurized heat recovery system,

wherein the CO₂ separation system reduce the CO₂ content from said partially condensed product to produce a CO₂-lean liquid product, and

wherein the pressurized heat recovery system utilizes latent heat of the mixed vapour stream to produce a lower pressure vapour stream from the CO₂-lean liquid product exiting the CO₂ separation system.

According to one embodiment of the invention, the pressurized heat recovery system comprises at least one heat exchangers.

According to one embodiment of the invention, the pressurized heat recovery system comprises a plurality of heat exchangers, said heat exchangers are arranged in parallel, series, or a combination thereof, configurations.

According to one embodiment of the invention, duty of any single heat exchanger has an upper limit of 100 MW (thermal).

According to one embodiment of the invention, the vapour stream is at a pressure of 0-200 bar and in a temperature range from 100 to 1000° C.

According to one embodiment of the invention, pressure differential between outlet of the direct contact steam generation and outlet of the CO2 separation system is such that the minimum approach temperature of the heat exchangers is at least 30° C.

According to one embodiment of the invention, removal of CO2 content in the CO2 separation system is by at least one of a single stage flash, multi-stage flash, packed column and trayed column.

According to one embodiment of the invention, the CO2 separation system comprises one or more low pressure CO2 separators, one or more high pressure CO2 separators, or both.

According to one embodiment of the invention, CO2 content in the CO2-lean liquid product is reduced to between 0 to 5% by mass before being sent back to the pressurized heat recovery system to be re-evaporated.

According to one embodiment of the invention, the water and gas introduced into the direct contact steam generation system are produced from a Steam Assisted Gravity Drainage system.

Other features and advantages of the present invention will become apparent from the following detailed description and the accompanying drawings, which illustrate, by way of example, the principles of the invention.

### BRIEF DESCRIPTION OF THE DRAWINGS

By way of example only, preferred embodiments of the present invention are described hereinafter with reference to the accompanying drawings, wherein:

FIG. 1 is a process flow diagram of the general process and system according to the present disclosure for removing CO₂ from steam.

FIG. 2 is a process flow diagram of the process and system according to an illustrative preferred embodiment of the present disclosure for removing CO₂ from steam using a CO₂ separation column.

FIG. 3 is a process flow diagram of the process and system according to an illustrative preferred embodiment of the present disclosure for removing CO₂ from steam using multiple heat exchangers.

### DETAILED DESCRIPTION OF THE INVENTION

The present invention discloses a method and system of processing flue gas to separate the CO₂ from the steam for sequestration.

The system comprises three components:
a direct contact steam generation system;
a pressurized heat recovery system; and
a CO₂ separation system.

A person skilled in the art would understand that each component as identified above may be oriented in various ways depending on the operator's required capacity and the requirement of the CO₂ content.

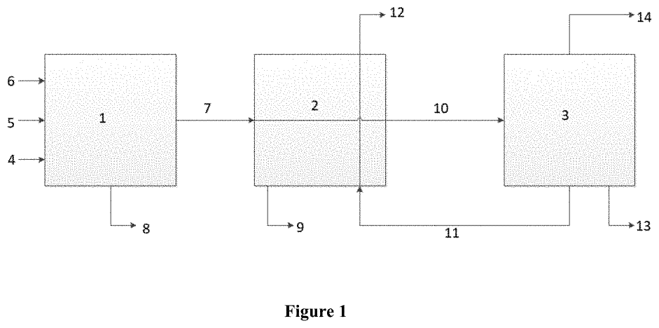

Referring to FIG. 1, an embodiment of the system of the present invention is shown.

### List of Reference Characters in FIG. 1

1 direct contact steam generation system
2 pressurised heat recovery system
3 CO₂ separation system
4 a gaseous, liquid, or solid fuel entering the direct contact steam generation system
5 oxidant entering the direct contact steam generation system
6 moderator water entering the direct contact steam generation system
7 mixed vapour stream exiting the direct contact steam generation system and entering the pressurised heat recovery system
8 blowdown/Ash exiting the direct contact steam generation system to the atmosphere
9 blowdown exiting the pressurised heat recovery system
10 partially condensed steam and CO₂ mixture exiting the pressurised heat recovery system and entering the CO₂ separation system
11 CO₂-lean liquid product exiting the CO₂ separation system and entering the pressurised heat recovery system
12 low pressure vapor stream exiting the pressurised heat recovery system
13 blowdown exiting the CO₂ separation system
14 CO₂ exiting the CO₂ separation system

Referring to FIG. 1, the three components operating together are further described in detail below:

The direct contact steam generation system 1 converts a gaseous, liquid or solid fuel 4, in the presence of oxygen 5, all of which have been introduced into the direct contact steam generation system 1 through inlet(s), and using moderator water 6, to produce a mixed vapour stream 7. The mixed vapour stream 7 contains approximately 85-95% by mass of water and 5-15% by mass of CO₂.

The combustor in the direct contact steam generation system 1 may be operated in fuel-rich or fuel-lean modes depending on the operator's requirements. The vapour stream may be at a pressure of 0-200 bar and in a temperature range from 100 to 1000° C.

The mixed vapour stream 7 exiting the direct contact steam generation system 1 is then led into a pressurized heat recovery system 2.

As shown in FIG. 1, the pressurized heat recovery system 2 is connected to the direct contact steam generation system 1 and the CO₂ separation system 3, such that the pressurized heat recovery system 2 utilizes the latent heat of the mixed vapour stream 7 to produce a lower pressure vapour stream 12 from the CO₂-lean liquid product 11 exiting the CO₂ separation system 3, achieved in a single or multiple heat exchanger(s) (not shown) arranged in parallel or series (or a combination thereof) configurations contained within the pressurized heat recovery system 2.

A preferred embodiment would place an upper limit of 100 MW (thermal) on the duty of any single heat exchanger.

In general, it would be preferable to select the pressure differential between the direct contact steam generation outlet and the CO₂ separation system such that the minimum approach temperature (i.e., temperature difference between the leaving process liquid and the entering liquid) of the heat exchangers is at least 30° C. This temperature difference can be reduced. However, the reduction may result in excessively large heat exchanger sizes.

A person skilled in the art would understand that the number and/or size of the heat exchanger(s) to be employed depend on the capacity of the facility and the required steam generation rate.

The CO₂ separation system manipulates the partially condensed product, which is produced from the direct contact steam generation system and then passed through the pressurized heat recovery system, in order to reduce the CO₂ content in the liquid phase to the desired level. The separation may be achieved through a single stage flash, multi-stage flash, packed column or trayed column. The temperature and pressure of the liquid phase is manipulated such that the solubility of CO₂ in the liquid phase (predominantly water) is controlled.

Depending on system configuration, the CO₂ content in the CO₂-lean liquid product 11 may be reduced to between 0 to 5% by mass before being sent back to the pressurized heat recovery system to be re-evaporated.

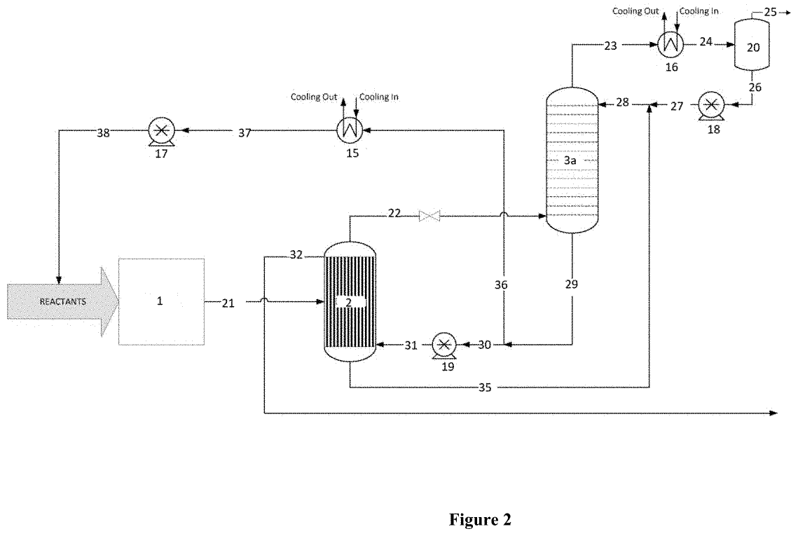

FIG. 2 is a scheme of an illustrative preferred embodiment comprising a direct contact steam generation system, pressurized heat recovery system, and a CO₂ separation system using a CO₂ separation column.

### List of Reference Characters in FIG. 2

1 direct contact steam generation system (combustor/steam generator)
2 pressurized heat recovery system
3a carbon dioxide/water separation column (may act as, or being part of, a CO₂ separation system)
15 recycled water heat exchanger
16 reflux condenser
17 recycle water pump
18 reflux pump
19 boiler feed pump
20 reflux vessel

Referring to FIG. 2, flue gas (shown as stream 21) coming out of the direct contact steam generation (combustor/steam generator) 1 is condensed inside of a pressurized heat recovery system 2.

The vapour phase (shown as stream 22) coming out of the pressurized heat recovery system 2 is then flashed and directed into the bottom of the CO₂/Water Separation Column (shown as 3a) where it flows counter-current to injected liquid condensate, which further removes water from the flue gas.

CO₂/Water Separation Column 3a may act as, or being part of, a CO₂ separation system 3 as noted hereinabove.

The flue gas then follows stream 23 and 24 where it is passed through reflux condenser 16 and into reflux vessel 20 where the condensate (shown as stream 26) is separated from the flue gas (shown as stream 25), which now has a CO₂ composition of >85 mol % suitable for sequestration.

The liquid condensate stream out of reflux vessel 20 is then re-pressurized through a reflux pump 18 as stream 27 and mixed with the liquid condensate from pressurized heat recovery system 2 (shown as stream 35) before being injected into the top of separation column 3a (shown as stream 28).

The liquid stream coming out of separation column 3a is re-pressurized and directed to the pressurized heat recovery system 2 (shown as stream 29, 30, and 31) where said stream captures the heat from the direct contact steam generation system 1 (through its outlet) flue gas to produce high-purity steam containing <2 mol % CO₂ (shown as stream 32) suitable for Steam Assisted Gravity Drainage applications.

Alternatively, the liquid condensate stream coming out of the separation column 3a may be cooled with recycled water heat exchanger 15 and to within operational limits of recycle water pump shown as 16, and re-pressurized for injection back into the direct contact steam generation system (combustor/steam generator) 1 as shown by streams 36, 37 and 38.

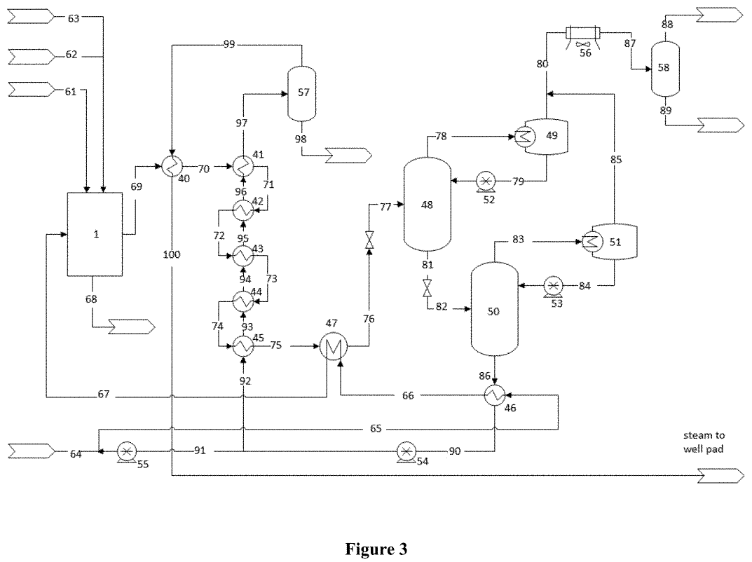

FIG. 3 is a process flow diagram of the process and system according to an illustrative preferred embodiment of the present disclosure for removing CO₂ from steam using multiple heat exchangers.

### List of Reference Characters in FIG. 3

1 direct contact steam generation (DC SG) system
40 superheater
41 heat exchanger 1
42 heat exchanger 2
43 heat exchanger 3
44 heat exchanger 4
45 heat exchanger 5
46 feed water heater 1 (FWH1)
47 feed water heater 2 (FWH2)
48 high pressure CO₂ separator (HP SEP)
49 high pressure separator chiller (HPSC)
50 low pressure CO₂ separator (LP SEP)
51 low pressure separator chiller (LPSC)
52 pump 1
53 pump 2
54 pump 3
55 pump 4
55 air cooler 1 (AC1)
57 vessel 1
58 vessel 2

The Streams as depicted in FIG. 3 and their characteristics are summarized below:

| Stream # | Description | Comments |
|---|---|---|
| 61 | Oxidant supply | |
| 62 | Produced gas from Steam Assisted Gravity | |
| | Drainage (SAGD) facility | |
| 63 | Fuel supply | |
| 64 | Produced water from SAGD facility | |
| 65 | Produced water/Recycle Water | |
| 66 | Preheated water | |
| 67 | Preheated water | 180-300° C., |
| | | 20-200 barg |
| 68 | Blowdown | 1-5% of stream 6 |
| 69 | direct contact steam generation | 200-1000° C. |
| | product gas | |
| 70 | Partially condensed DCSG product gas | |
| 71 | Partially condensed DCSG product gas | |
| 72 | Partially condensed DCSG product gas | |
| 73 | Partially condensed DCSG product gas | |
| 74 | Partially condensed DCSG product gas | |
| 75 | Partially condensed DCSG product gas | |
| 76 | Partially condensed DCSG product gas | |
| 77 | Partially condensed DCSG product gas | 150-350° C. |
| 78 | HP SEP off-gas | 110-300° C., |
| | | 10-100 barg, |
| 79 | HP SEP off-gas condensate | |
| 80 | Chilled HP SEP off-gas | 20-200° C. |
| 81 | HP SEP condensate | |
| 82 | HP SEP condensate | |
| 83 | LP SEP off-gas | 100-300° C. |
| 84 | LP SEP off-gas condensate | |
| 85 | Chilled LP SEP off-gas | 20-200° C. |
| 86 | LP SEP condensate | |
| 87 | CO₂ | |
| 88 | Dry CO₂ | |
| 89 | CO₂ dryer condensate | |
| 90 | LP SEP condensate | |
| 91 | Recycle water | |
| 92 | Evaporator feed water | |
| 93 | Partially evaporated water | |
| 94 | Partially evaporated water | |
| 95 | Partially evaporated water | |
| 96 | Partially evaporated water | |
| 97 | Partially evaporated water | |
| 98 | Blowdown | |
| 99 | Saturated vapour | |
| 100 | Superheated steam (CO₂ lean) | 150-350° C., |
| | | 0-5% CO₂ |

The system and method describe herein uses a new process configuration for separating CO₂.

By operating the system as described herein over a range of pressures, the separation efficiency can be varied thereby allowing the system to produce a high degree of CO₂ separation if required.

By utilizing this system, the product stream can be varied over the life of a reservoir.

The system and method described can vary the amount of CO₂ separation and can be used to vary the CO₂ separation over the life of a reservoir.

Preferably, the CO₂ fraction of the injected steam is controlled to within 0-5% by mass.

Although the present invention has been described in considerable detail with reference to certain preferred embodiments thereof, other embodiments and modifications are possible. Therefore, the scope of the appended claims should not be limited by the preferred embodiments set forth in the examples, but should be given the broadest interpretation consistent with the description as a whole.

1. A system for carbon dioxide removal from a product from a direct contact steam generation system, comprising:
the direct contact steam generation system;
a pressurized heat recovery system;
a CO₂ separation system;
wherein the direct contact steam generation system converts a gaseous, liquid or solid fuel, in the presence of an oxidant and using a moderator water, the fuel, oxygen and water are introduced into the direct contact steam generation system through inlets, to produce a mixed vapour stream;
wherein the mixed vapour stream is then led into the pressurized heat recovery system through connecting means between the direct contact steam generation system and the pressurized heat recovery system to produce a partially condensed product;
wherein the partially condensed product is led into the CO₂ separation system through connecting means between the pressurized heat recovery system and the pressurized heat recovery system;
wherein the CO₂ separation system reduces the CO₂ content from the partially condensed product to produce a CO₂-lean liquid product; and
wherein the pressurized heat recovery system utilizes a latent heat of the mixed vapour stream to produce a lower pressure vapour stream from the CO₂-lean liquid product exiting the CO₂ separation system.

2. The system according to claim 1, wherein the pressurized heat recovery system comprises at least one heat exchanger.

3. The system according to claim 1, wherein the pressurized heat recovery system comprises a plurality of heat exchangers and the heat exchangers are arranged in parallel, series, or a combination thereof.

4. The system according to claim 2, wherein a duty of any single heat exchanger has an upper limit of 100 MW (thermal).

5. The system according to claim 1, wherein the vapour stream is at a pressure of 0-200 bar and in a temperature range from 100 to 1000° C.

6. The system according to claim 1, wherein a pressure differential between an outlet of the direct contact steam generation and an outlet of the CO₂ separation system is such that the minimum approach temperature of the heat exchangers is at least 30° C.

7. The system according to claim 1, wherein removal of the CO₂ content in the CO₂ separation system is by at least one of a single stage flash, multi-stage flash, packed column and trayed column.

8. The system according to claim 1, wherein the CO₂ separation system comprises one or more low pressure CO₂ separators, one or more high pressure CO₂ separators, or both.

9. The system according to claim 1, wherein the CO₂ content in the CO₂-lean liquid product is reduced to between 0 to 5% by mass before being sent back to the pressurized heat recovery system to be re-evaporated.

10. The system according to claim 1, wherein the water and gas introduced into the direct contact steam generation system are produced from a Steam Assisted Gravity Drainage system.
